(19) United States
(12) Patent Application Publication
(10) Pub. No.: US 2005/0140902 A1
(43) Pub. Date: Jun. 30, 2005

(54) In plane switching liquid crystal display with transflector

(76) Inventors: Chiu-Lien Yang, Miao-Li (TW); Chueh-Ju Chen, Miao-Li (TW); Jia-Pang Pang, Miao-Li (TW)

Correspondence Address: WEI TE CHUNG;FOXCONN INTERNATIONAL, INC., 1650 MEMOREX DRIVE, SANTA CLARA, CA, 95050, US

(21) Appl. No.: 10/997,523

(22) Filed: Nov. 24, 2004

(30) Foreign Application Priority Data
Dec. 31, 2003 (TW) 92137543

(51) Int. Cl. G02F 1/1343

(52) U.S. Cl. 349/141; 349/114

(57) ABSTRACT

An in plane switching liquid crystal display (2) includes a first substrate (220) and a second substrate (210) disposed opposite each other and spaced apart a predetermined distance. A liquid crystal layer is interposed between the first substrate and the second substrate, the liquid crystal layer containing a plurality of liquid crystal molecules (230). A plurality of pixel electrodes (213) and a plurality of counter electrodes (211) are formed on the first substrate in parallel alternating fashion. Two polarizers (240, 241) are disposed on the first substrate and the second substrate, respectively. A transflector (217) capable of transmitting and reflecting light beams is disposed on the first substrate. The in plane switching liquid crystal display can thus utilize ambient light beams as well as light beams provided by a backlight, so that the in plane switching liquid crystal display has low power consumption.

### BACKGROUND OF THE INVENTION

1. Field of the Invention

The present invention relates to in plane switching liquid crystal displays (IPS-LCDs), and especially to a transflective mode IPS-LCD having low power consumption.

2. Description of the Prior Art

The in-plane switching liquid crystal display (IPS-LCD) has been developed in order to improve on the narrow viewing angle of the more traditional twisted nematic liquid crystal display (TN-LCD). The IPS-LCD has a plurality of counter electrodes and a plurality of pixel electrodes all disposed on a same substrate of two opposite substrates, for driving liquid crystal molecules that are disposed in a liquid crystal layer between the substrates. The resulting electric field is substantially planar and parallel to a surface of said same substrate. This configuration provides an improved viewing angle for the IPS-LCD.

Referring to FIG. 3, this is a cross-sectional representation of a conventional IPS-LCD 1. The IPS-LCD 1 is a transmissive mode LCD, which utilizes a backlight for illuminating. The IPS-LCD 1 comprises an upper substrate 10 and a lower substrate 20 disposed opposite to each other and spaced apart a predetermined distance. A liquid crystal layer (not labeled) having a plurality of liquid crystal molecules 30 is disposed between the upper and lower substrates 10, 20. A plurality of counter electrodes 11 and a plurality of pixel electrodes 13 are disposed on the lower substrate 20, with an insulating layer 12 and an alignment film 14 disposed on the counter and pixel electrodes 11, 13, in that order from bottom to top. A lower polarizer 41 is formed on an undersurface of the lower substrate 20, the lower polarizer 41 being an ordinary type polarizer. A color filter 15 and an alignment film 16 are disposed on an undersurface of the upper substrate 10, in that order from top to bottom.

An upper polarizer 40 is formed on a top surface of the upper substrate 10, the upper polarizer 40 also being an ordinary type polarizer. Polarization axes of the upper polarizer 40 and the lower polarizer 41 are perpendicular to each other.

The color filter 15 comprises a black matrix (not shown), and a color resin layer (not shown) having Red, Green and Blue segments. The color filter 15 is disposed between (but not adjacent) the upper polarizer 40 and the liquid crystal layer. The color filter 15 has a de-polarizing effect on light beams passing therethrough due to pigment light scattering, therefore light beams passing through the IPS-LCD 1 are at least partially de-polarized by the color filter 15 before reaching the upper polarizer 40. This de-polarizing of the light beams prior to them reaching the upper polarizer 40 can reduce the contrast ratio of the IPS-LCD 1. Even though such de-polarizing effects are small, they can have a significant effect on the contrast ratio of the IPS-LCD 1.

The counter electrodes 11 and the pixel electrodes 13 are strip-shaped, and are arranged parallel to each other in alternating fashion. The counter electrodes 11 and the pixel electrodes 13 are transparent conductors, being made of a material such as indium tin oxide (ITO). When the IPS-LCD 1 is driven, an electric field having a component parallel to main surfaces of the substrates 10, 20 is formed at upper portions of the counter electrodes 11 and the pixel electrodes 13. The liquid crystal molecules 30 disposed over the counter and pixel electrodes 11, 13 are driven, thus giving the IPS-LCD 1 an improved wide viewing angle compared to that of a TN-LCD.

However, the IPS-LCD 1 is a transmissive mode LCD, which depends on a backlight for illumination. The backlight typically uses 50% or more of the total power consumed by the IPS-LCD 1.

It is desired to provide an IPS-LCD that can solve the above-mentioned high power consumption problem.

### SUMMARY OF THE INVENTION

An object of the present invention is to provide an in plane switching liquid crystal display which has low power consumption.

To achieve the above object, an in plane switching liquid crystal display of the present invention includes a first substrate and a second substrate disposed opposite each other and spaced apart a predetermined distance. A liquid crystal layer is interposed between the first substrate and the second substrate, with a plurality of liquid crystal molecules contained in the liquid crystal layer. A plurality of pixel electrodes and a plurality of counter electrodes are formed on the first substrate in alternating fashion. Two polarizers are disposed on the first substrate and the second substrate, respectively. A transflector capable of transmitting and reflecting light beams is disposed on the first substrate. The in plane switching liquid crystal display can thus utilize ambient light beams as well as light beams provided by a backlight, so that the in plane switching liquid crystal display has low power consumption.

Other objects, advantages, and novel features of the present invention will become more apparent from the following detailed description when taken in conjunction with the accompanying drawings, in which:

### BRIEF DESCRIPTION OF THE DRAWINGS

FIG. 1 is a schematic, cross-sectional view of part of an IPS-LCD according to a first embodiment of the present invention;

FIG. 2 is a schematic, cross-sectional view of part of an IPS-LCD according to a second embodiment of the present invention; and

FIG. 3 is a schematic, cross-sectional view of part of a conventional IPS-LCD.

### DETAILED DESCRIPTION OF THE INVENTION

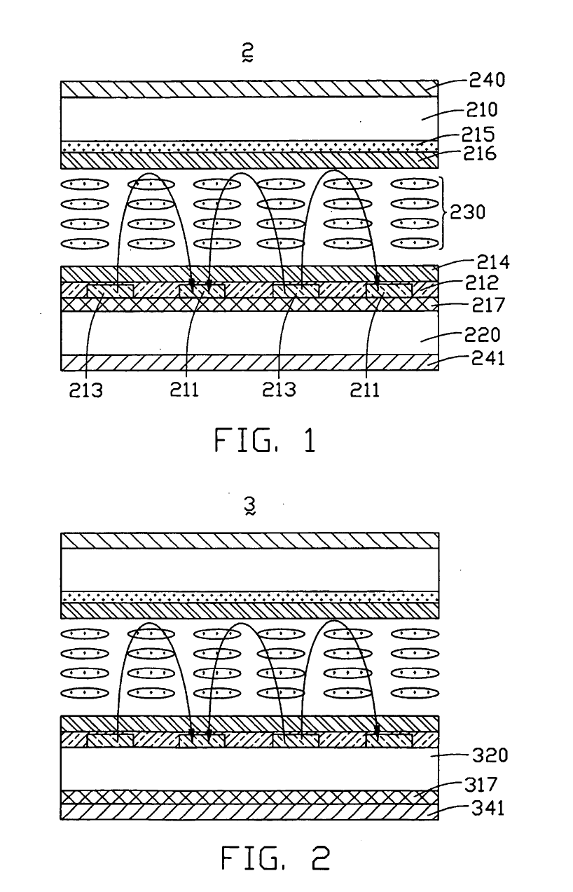

FIG. 1 is a schematic, cross-sectional view of an in plane switching liquid crystal display (IPS-LCD) 2 according to the first embodiment of the present invention. The IPS-LCD 2 comprises a first substrate 220, a second substrate 210, and a liquid crystal layer (not labeled) having a plurality of liquid crystal molecules 230. The first substrate 220 and the second substrate 210 are spaced apart from each other, and the liquid crystal layer is disposed therebetween. The first substrate 220 and the second substrate 210 are made of glass. Alternatively, the first substrate 220 and the second substrate 210 can be made of silicon dioxide (SiO₂).

A plurality of gate bus lines (not shown) and a plurality of data bus lines (not shown) are cross-arranged on an inner surface of the first substrate 220. A plurality of thin film transistors (not shown) is disposed at intersections of the gate bus lines and the data bus lines. A plurality of counter electrodes 211 and a plurality of pixel electrodes 213 are disposed on the first substrate 220, with a transparent insulating layer 212 and an alignment film 214 disposed on the counter and pixel electrodes 211, 213 in that order from bottom to top. A transflector 217 is interposed between the counter and pixel electrodes 211, 213 and the first substrate 220. A color filer 215 and an alignment film 216 are formed on an underside of the second substrate 210, in that order from top to bottom. Two polarizers 241, 240 are formed on two outer surfaces of the first substrate 220 and the second substrate 210, respectively.

The alignment films 214, 216 are horizontal alignment layers. Alignment directions of the alignment films 214, 216 are parallel to each other, or alternatively an angle of 180 degrees may be formed between the alignment directions. Polarization axes of the polarizers 241, 240 are perpendicular to each other. The polarizers 241, 240 are ordinary type polarizers. The alignment direction of the alignment film 214 is parallel to the polarization axis of the polarizer 241.

The counter electrodes 213 and the pixel electrodes 211 are strip-shaped, and are arranged parallel to each other in alternating fashion on the transflector 217. The counter electrodes 213 and the pixel electrodes 211 are made of a transparent conductor, such as indium tin oxide (ITO) or indium zinc oxide (IZO). The transparent insulating layer 212 is made of SiO₂ or silicon nitride (SiNx), to prevent the counter electrodes 213 and the pixel electrodes 211 from shorting and to protect them.

The transflector 217 is a multiple-layered structure, with ITO layers (not shown) and titanium dioxide (TiO₂) layers (not shown) stacked one on the other in alternating fashion. Each ITO layer has a high refractive index, and each TiO₂ layer has a low refractive index. Therefore, the multiple-layer structure can reflect light beams as well as transmit light beams. A desired ratio of light beams reflected by the transflector 217 to light beams transmitted by the transflector 217 is obtained by selecting the thicknesses and the refractive indexes of the layers having different refractive indexes accordingly.

The color filter 215 comprises a black matrix (not shown), and a color resin layer (not shown) having Red, Green and Blue segments. The black matrix is disposed between the segments of the color resin layer. The black matrix is used to prevent light beams from leaking from the IPS-LCD 2, and to protect the thin film transistors from damage.

When no voltage is applied to the counter electrodes 213 and pixel electrodes 211, the liquid crystal molecules 230 are arranged substantially parallel to the first substrate 220 and the second substrate 210. The state of polarization of light beams is not changed when they pass through the liquid crystal layer. Therefore the light beams, whether they be light beams from a backlight or light beams from the ambient environment, cannot pass through the polarizer 240. As a result, the IPS-LCD 2 is in a dark state. When a voltage is applied to the counter electrodes 213 and the pixel electrodes 211, an electric field having horizontal components is produced therebetween. Long axes of the liquid crystal molecules 230 are parallel to the direction of the horizontal components of the electric field. The polarization state of light beams is changed when the light beams pass through the liquid crystal layer. Therefore the light beams can pass through the polarizer 240. As a result, the IPS-LCD 2 is in a white state.

The transflector 217 can reflect ambient light beams and transmit light beams from a backlight for display. Therefore, the IPS-LCD 2 is a transflective mode liquid crystal display. Because the transflective mode LCD can make use of both internal and external light sources, it can be operated in a bright ambient light environment with low power consumption. Further, the IPS-LCD 2 has a wide viewing angle compared to other kinds of LCDs.

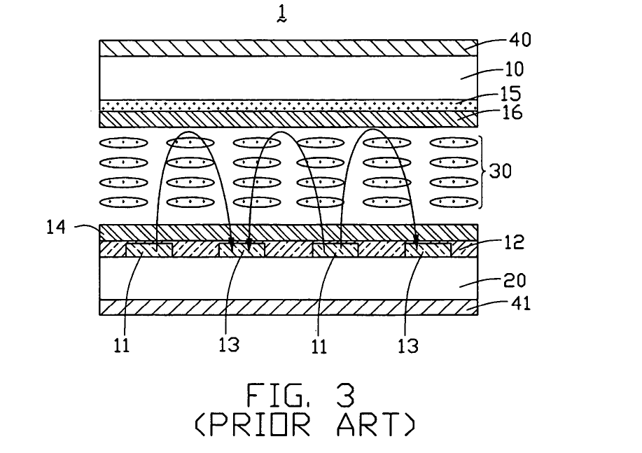

Referring to FIG. 2, this shows a schematic, cross-sectional view of an IPS-LCD 3 according to the second embodiment of the present invention. The IPS-LCD 3 is the same as the IPS-LCD 2 of the first embodiment, except that the IPS-LCD 3 has a transflector 317 disposed between a first substrate 320 and a polarizer 341.

In alternative embodiments, the transflector 217, 317 of the present invention may be made of a material having high reflectivity, such as aluminum or silver. Further, the transflector 217, 317 may define a plurality of holes therein for free transmission of light beams therethrough. The holes may, for example, be circular, elliptical or polygonal. A desired ratio of light beams reflected by the transflector 217, 317 to light beams transmitted by the transflector 217, 317 is obtained by configuring areas of the holes accordingly.

In other alternative embodiments, at least one of the polarizers 240, 241, 341 of the present invention may be an extraordinary type polarizer. The extraordinary type polarizer can improve a transmission ratio and an aperture ratio of the IPS-LCD 2, 3. Further, the polarizer 240 can be disposed between the color filter 215 and the alignment film 216. This arrangement reduces or eliminates the adverse effects of color filter de-polarizing, and yields a higher contrast ratio.

In still another alternative embodiment, the counter electrodes 211 and the pixel electrodes 213 are disposed on the second substrate 210 and the first substrate 220 respectively, in order to generate an electric field having horizontal components parallel to the surfaces of the first substrate 220 and the second substrate 210.

In summary, the IPS-LCD 2, 3 of the present invention is a transflective mode liquid crystal display, which can make use of both internal and external light sources. Therefore, the IPS-LCD 2, 3 can be operated in a bright ambient light environment with low power consumption. Furthermore, the IPS-LCD 2, 3 has a wide viewing angle compared to other kinds of LCDs.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

1. An in plane switching liquid crystal display comprising:
a first substrate and a second substrate disposed opposite each other and spaced apart a predetermined distance;
a liquid crystal layer interposed between the first substrate and the second substrate;
a plurality of pixel electrodes and a plurality of counter electrodes formed on the first substrate;
two polarizers formed at the first substrate and the second substrate, respectively; and
a transflector disposed on the first substrate.

2. The in plane switching liquid crystal display as claimed in claim 1, wherein the transflector has a multiple-layered structure, in which layers having different refractive indexes are stacked one on the other in alternating fashion.

3. The in plane switching liquid crystal display as claimed in claim 2, wherein the transflector comprises indium tin oxide (ITO) layers and titanium dioxide (TiO₂) layers.

4. The in plane switching liquid crystal display as claimed in claim 1, wherein the transflector comprises aluminum or silver.

5. The in plane switching liquid crystal display as claimed in claim 4, wherein the transflector defines a plurality of holes.

6. The in plane switching liquid crystal display as claimed in claim 5, wherein the holes are circular, elliptical or polygonal.

7. The in plane switching liquid crystal display as claimed in claim 1, wherein the transflector is disposed between the first substrate and the liquid crystal layer, or is disposed on an undersurface of the first substrate.

8. The in plane switching liquid crystal display as claimed in claim 1, wherein each counter electrode and each pixel electrode is strip-shaped.

9. The in plane switching liquid crystal display as claimed in claim 1, wherein the polarizer of the second substrate is disposed at an inner side thereof, said inner side corresponding to the liquid crystal layer.

10. The in plane switching liquid crystal display as claimed in claim 1, wherein at least one of the polarizers is an extraordinary type polarizer.

11. An in plane switching liquid crystal display comprising:
a first substrate and a second substrate disposed opposite each other and spaced apart a predetermined distance;
a liquid crystal layer interposed between the first substrate and the second substrate;
a plurality of pixel electrodes and a plurality of counter electrodes formed on the first substrate;
two polarizers formed on the first substrate and the second substrate, respectively; and
a film disposed on the first substrate, the film being able to reflect light beams as well as transmit light beams.

12. The in plane switching liquid crystal display as claimed in claim 11, wherein the film has a multiple-layered structure, in which layers having different refractive indexes are stacked one on the other in alternating fashion.

13. The in plane switching liquid crystal display as claimed in claim 12, wherein the film comprises indium tin oxide (ITO) layers and titanium dioxide (TiO₂) layers.

14. The in plane switching liquid crystal display as claimed in claim 11, wherein the film comprises aluminum or silver.

15. The in plane switching liquid crystal display as claimed in claim 14, wherein the film defines a plurality of holes.

16. The in plane switching liquid crystal display as claimed in claim 15, wherein the holes are circular, elliptical or polygonal.

17. The in plane switching liquid crystal display as claimed in claim 11, wherein the film is disposed between the first substrate and the liquid crystal layer, or is disposed on an undersurface of the first substrate.

18. An in plane switching liquid crystal display comprising:
a first substrate and a second substrate disposed opposite each other and spaced apart a predetermined distance;
a liquid crystal layer interposed between the first substrate and the second substrate;
a plurality of pixel electrodes and a plurality of counter electrodes, wherein an electric field having horizontal components is generated between the pixel electrodes and the counter electrodes when a voltage is applied therebetween;
two polarizers formed on the first substrate and the second substrate, respectively; and
a film disposed on the first substrate, the film reflecting light beams as well as transmitting light beams.

19. The in plane switching liquid crystal display as claimed in claim 18, wherein the pixel electrodes and the counter electrodes are all disposed on the first substrate, or are disposed on the first substrate and the second substrate respectively.
